(19) United States
(12) Patent Application Publication
(10) Pub. No.: US 2025/0269785 A1
(43) Pub. Date: Aug. 28, 2025

(54) WALL PANEL FOR CARGO COMPARTMENT

(71) Applicant: Ancra International LLC, Hebron, KY (US)

(72) Inventors: Jerome Thomas JONES, Independence, KY (US); Mathew James ROMMEL, Independence, KY (US)

(21) Appl. No.: 19/061,144

(22) Filed: Feb. 24, 2025

Related U.S. Application Data
(60) Provisional application No. 63/557,933, filed on Feb. 26, 2024.

(51) Int. Cl. B60P 7/15

(52) U.S. Cl. CPC B60P 7/15

(57) ABSTRACT

The wall panel of the present disclosure includes first and second ends, each of which includes at least one tab that is configured to be insertable into one of these slots in a corresponding vertical wall post. Each tab further includes a protrusion configured to allow the wall panel, once the tabs are inserted into the vertical logistics posts slots, to be shifted downwards so that the protrusion engages with the bottom edge of the slot into which the tab is inserted into, preventing further downward and rotational movement so that the wall panel can be at least temporarily but safely held into place by the inserted tabs alone.

### CROSS-REFERENCE TO RELATED APPLICATIONS

This application claims the benefit of U.S. Provisional Application No. 63/557,933, filed Feb. 26, 2024 and entitled “WALL PANEL FOR CARGO COMPARTMENT.” The aforementioned application is hereby incorporated by reference in its entirety

### BACKGROUND

Cargo compartments, such as the interior of cargo containers widely used in the shipping industry, are often retrofitted with components that allow beam systems, including captive beam systems and decking systems, to be used. The inner walls of these cargo compartments may include integrated vertical logistics posts, which are typically installed at regular intervals along the interior of the cargo container walls. Elongated tracks may be mounted to these vertical logistics posts, which in turn allow for beam systems, e.g., captive beam systems, to be used to support an additional deck or to secure cargo in place (in a longitudinal direction). However, the positioning of these integrated vertical logistics posts, once installed, cannot be adjusted.

### BRIEF DESCRIPTION OF THE FIGURES

The present systems and methods for a wall panel for cargo compartment are described in detail below with reference to these figures.

FIG. 1A is a perspective view of a cargo container truck.

FIG. 1B is a side view of the rear of the cargo container truck of FIG. 1.

FIG. 2A is a perspective view of an example vertical logistics post.

FIG. 2B is a top down view of an example vertical logistics post integrated into a wall.

FIG. 2C is a top down view of a second example vertical logistics post integrated into a wall.

FIG. 3A is a perspective view of a wall panel in accordance with the disclosure herein.

FIG. 3B is a close up perspective view of the top portion of the wall panel of FIG. 3A.

FIG. 3C is a bottom view of the wall panel of FIG. 3A without an elongated track attached.

FIGS. 4A-C are multiple views of a tab of the wall panel of FIG. 3A.

FIGS. 5A and 5B are perspective view of the wall panel of FIG. 3A attached to a vertical logistics post.

FIG. 6 is a perspective view of an elongated track in accordance with the disclosure herein.

FIGS. 7A and 7B are bottom and side views of the wall panel of FIG. 3A with the elongated track of FIG. 6 attached.

FIG. 8 is a perspective view of the assembly of FIGS. 7A-B with an example captive beam and shoe attached to the elongated track.

FIG. 9 is a perspective view of an alternative example wall panel in accordance with the disclosure herein.

### DETAILED DESCRIPTION

The present disclosure is related to a wall panel for a cargo compartment that can be installed easily with minimal tooling and that can support cargo securement systems. In an example, the wall panel includes features that allow it to be held by pre-existing vertical logistics posts that are integrated into the interior walls of a cargo compartment. These features may be in the form of tabs or hooks that can engage apertures in the vertical logistics posts, and which can hold the wall panel in place without the use of other fasteners. A single user can maneuver the wall panel into position so that the tabs can be aligned with, inserted into and engaged with the apertures in the vertical logistics posts. The wall panel in turn can be used to support an elongated track or other components for securing cargo, providing a user more flexibility in the positioning of these securing components within the cargo compartment interior.

Cargo compartments, such as the interior of cargo containers widely used in the shipping industry, are often manufactured to include a series of vertical logistics posts spaced at regular intervals along a length of its interior walls. These vertical logistics provide connection points for a variety of cargo securement components (e.g., straps, beams) that can be used to secure cargo within the cargo compartment. However, because the vertical logistics posts are integrated into the compartment walls, their positioning cannot be easily adjusted, limiting their ability to be used to secure different sizes of cargo.

To address this, wall panels can be attached between vertical logistics posts, with the wall panels then providing connection points, such as apertures, in between the vertical logistics posts to which various components may be attached or supported. However, attaching the wall panels to the vertical logistics posts using conventional methods (e.g., fasteners such as screws and bolts) is time consuming and often requires multiple persons to perform the task; at least one person to hold the wall panel in position while at least one other person secures the wall panel to the vertical logistics posts with multiple fasteners that each need to be fastened.

The present disclosure provides a wall panel that addresses the above problems, while leveraging existing conventional wall-integrated vertical logistics posts. These vertical logistics posts typically include a central column with a plurality of slots, spaced evenly apart and running vertically along the central column (e.g., along the midline). The wall panel of the present disclosure includes first and second sides on either side of a planar body, with each side including at least one tab that is configured to be insertable into one of the plurality of slots in a vertical logistics post. Each tab further includes a protrusion configured to allow the wall panel, once the tabs are inserted into the vertical logistics posts slots, to be shifted downwards so that the protrusion engages with the bottom edge of the slot into which the tab is inserted, preventing further downward or rotational movement so that the wall panel is held into place by the inserted and engaged tabs alone.

In some examples, the wall panels can be fastened into place (e.g., in addition to be secured in place by the tabs) via screws or other fasteners, which can be affixed to the vertical posts or to other structures along the side wall of the cargo container). The present disclosure thus reduces the need for a person or persons to hold the wall panel into position while the fasteners are fastened, which improves the speed and safety of installation for the wall panel and reduces the number of persons required.

In an example, the wall panel includes a body portion having a plurality of apertures configured to engage with the end of a decking beam or other cargo securement components or systems.

In another example, the wall panel also includes a recess for receiving a standardized vertical elongate track, which is configured to receive and interact with an end of a captive beam.

In another example, the wall panel comprises one or more tabs on only one side of its planar body.

In examples, multiple wall panels that are substantially the same are installed adjacent each other to substantially cover the length of the cargo compartment wall. For instance, tabs from the two adjacent wall panels are configured so that both can be held at the same time by a single central column slot in the vertical logistics post. In some examples, adjacent wall panels can attach to different columns or slots.

The wall panel can be made of common materials (e.g., metal such as steel or aluminum) and can be manufactured via economical techniques such as stamping and pressing. These and other aspects are described further below with reference to the accompanying drawings. The drawings are merely example implementations, and should not be construed to limit the scope of the claims.

As used herein, the terms “about”, “approximately” and “substantially” mean +/−10% of a given value, such as a dimensional value (e.g., height, width, etc.). In addition, with respect to an angle, or the terms parallel and perpendicular, the terms “about” and “substantially” mean within 10 degrees. If “about” or “substantially” are otherwise used, the terms can, where appropriate, include equivalents of the modified element.

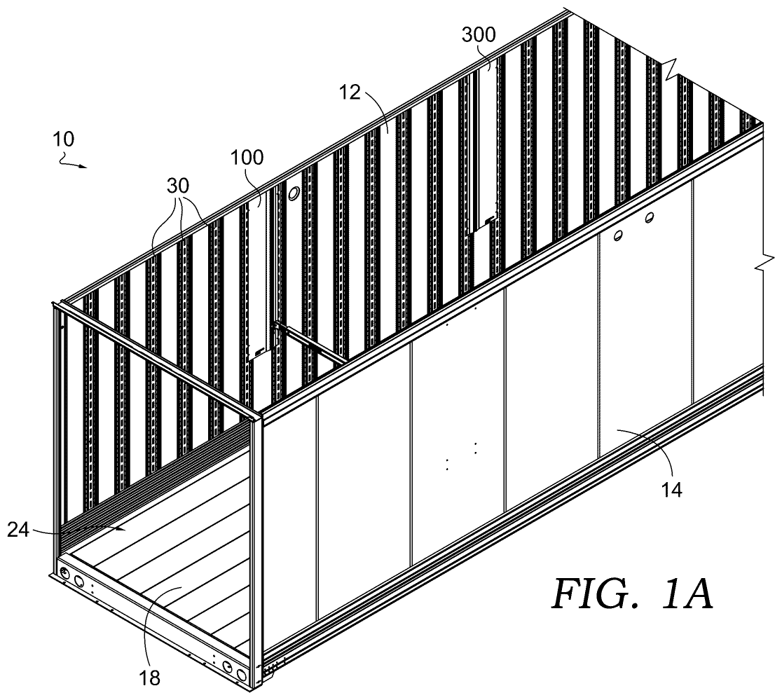

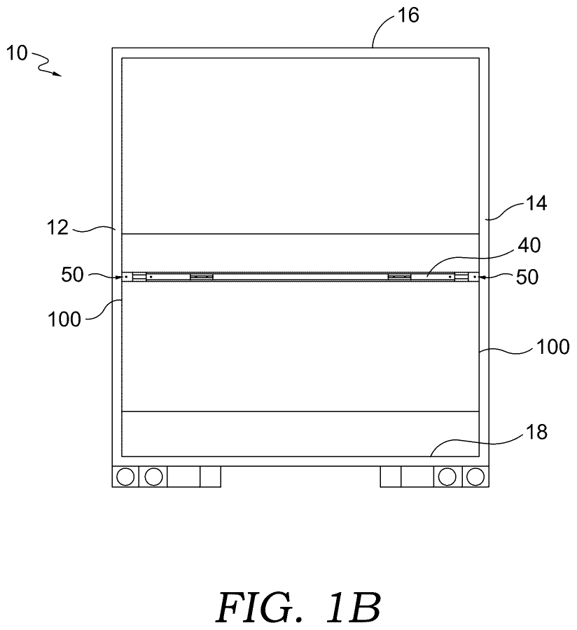

Referring to FIGS. 1A and 1B, a rear end of a cargo container 10 is depicted (with the ceiling removed), including a wall panel 100. The wall panel 100 may be used in the cargo compartment 24 of a mobile cargo container, such as a cargo container 10 attached to a truck (FIGS. 1A and 1B), a railroad car, a boat, an aircraft, or the like. One of ordinary skill in the art with reference to the subject specification and drawings will easily understand that the subject matter disclosed and claimed herein could be readily implemented for other movable objects that carry cargo in a secured manner, and can also be readily implemented for a stationary cargo compartment or structure, such as a storage unit.

Cargo container 10 comprises side walls 12, 14 on either side of a floor 18 and a ceiling 16. A front wall (not shown) encloses the front end of the cargo container 10, and a door panel or panels (not shown) enclose the back end. The side walls 12, 14, floor 18, ceiling 16, front wall and door panels define a cargo compartment 24 within the cargo container 10. The door panel(s) can open and close to provide access to the cargo compartment 24.

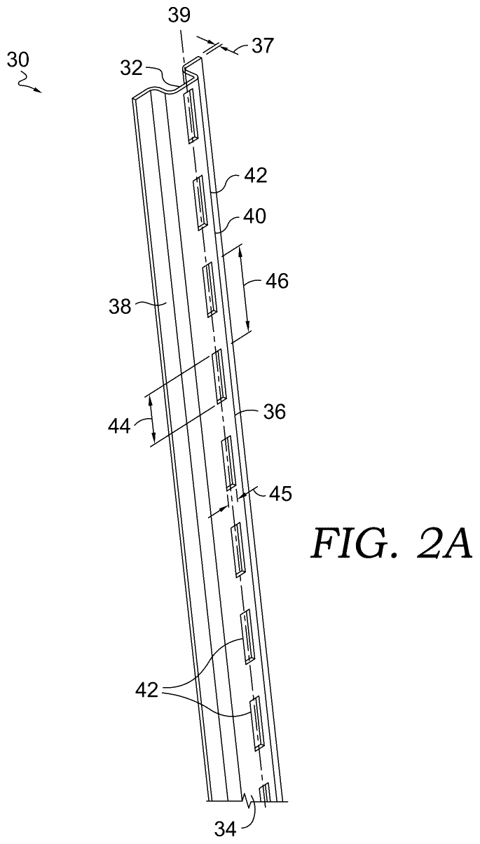

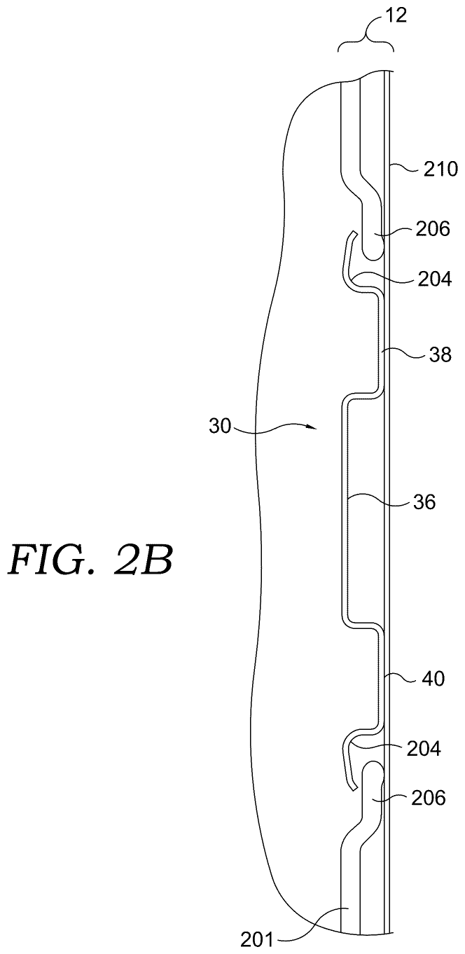

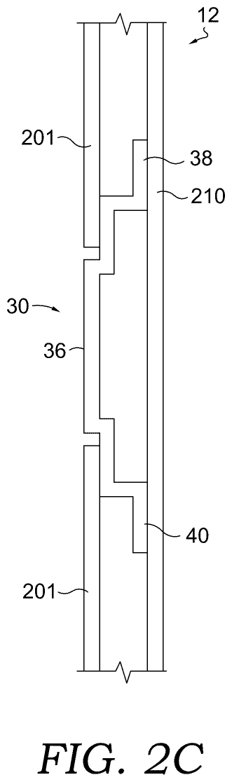

The wall panel 100 is configured to be positioned along the inner sides of side walls 12, 14 of the cargo compartment 24 and fixedly attached a plurality of vertical logistics posts 30, such as the one depicted in FIG. 2. Vertical logistics post 30 comprises a top end 32, a bottom end 34, a central column 36 and side flanges 38, 40 on either side of the central column 36. The side flanges 38, 40 may be used to secure the vertical logistics post 30 to one of the walls of the cargo compartment 24, e.g., using fasteners, adhesives, bonding, welding, or other well-known methods. The central column 36 includes a plurality of apertures 42, running along a centerline 39. In an example, the plurality of apertures 42 are rectangle-shaped with a longitudinal length 44, a width 45, and evenly spaced apart, with the top edges of adjacent apertures 42 being spaced a distance 46 apart. The apertures 42 can include other shapes as well, such as with tapering sides and/or with profiles configured to mate with other cargo securement components. The vertical logistics post 30 may be formed from sheet metal and formed by bending, stamping, machining, or a combination thereof. The various parts of a vertical logistics post 30 formed by bending and stamping will generally have the same or similar wall thickness 37 throughout, including the central column 36. Other suitable materials and manufacturing methods may also be used, depending upon costs, availability of materials and machinery, and design factors such as strength, durability, and weight.

FIGS. 2B and 2C show different examples of a vertical logistics post integrated into a wall of a cargo container, with the wall of the cargo container comprising an exterior wall 210 and an interior wall sections 201. In both examples, the side flanges 38, 40 of the vertical logistics post 30 are attached to an exterior wall 210 of the FIG. 2B, and the face of the central column 36 is generally aligned with the plane of the interior wall sections 201. In the example of FIG. 2B, the side flanges 38, 40 may also comprise guard edges 204 to protect the edges 206 of the interior wall sections 201.

Pairs of vertical logistics posts 30 may be installed opposite each other on either side wall 12, 14 of the cargo compartment 24. In the example shown in FIG. 1, a plurality of vertical logistics posts 30 are spaced evenly apart along both side walls 12, 14, with the midlines of adjacent vertical logistics posts spaced 24 inches apart. It is contemplated that other spacings can also be utilized in accordance with the present disclosure.

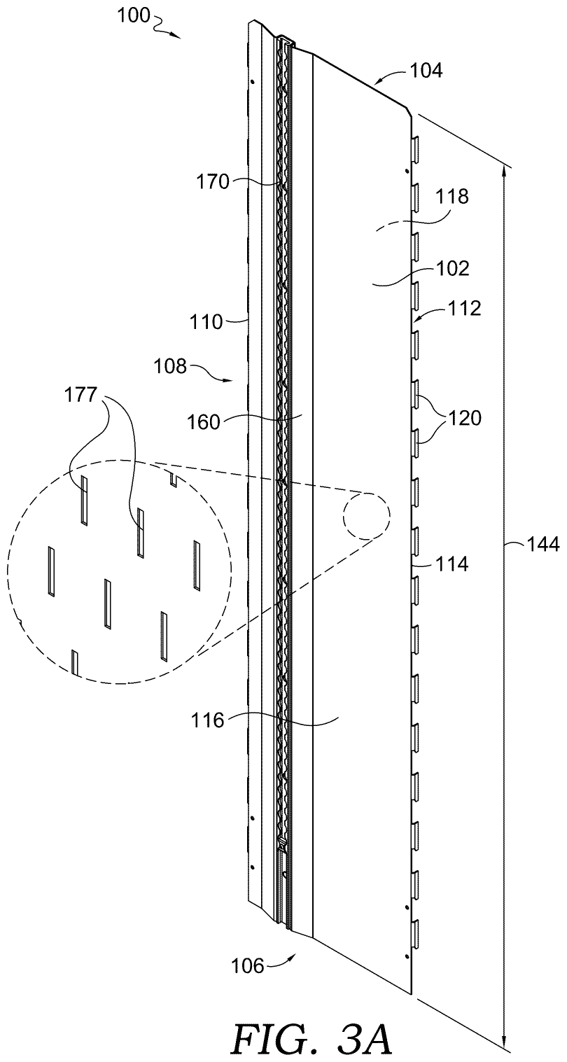

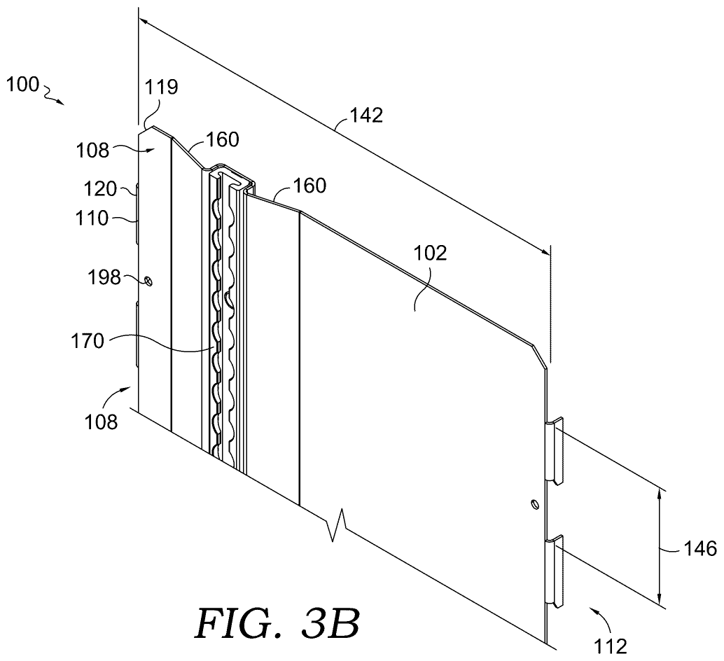

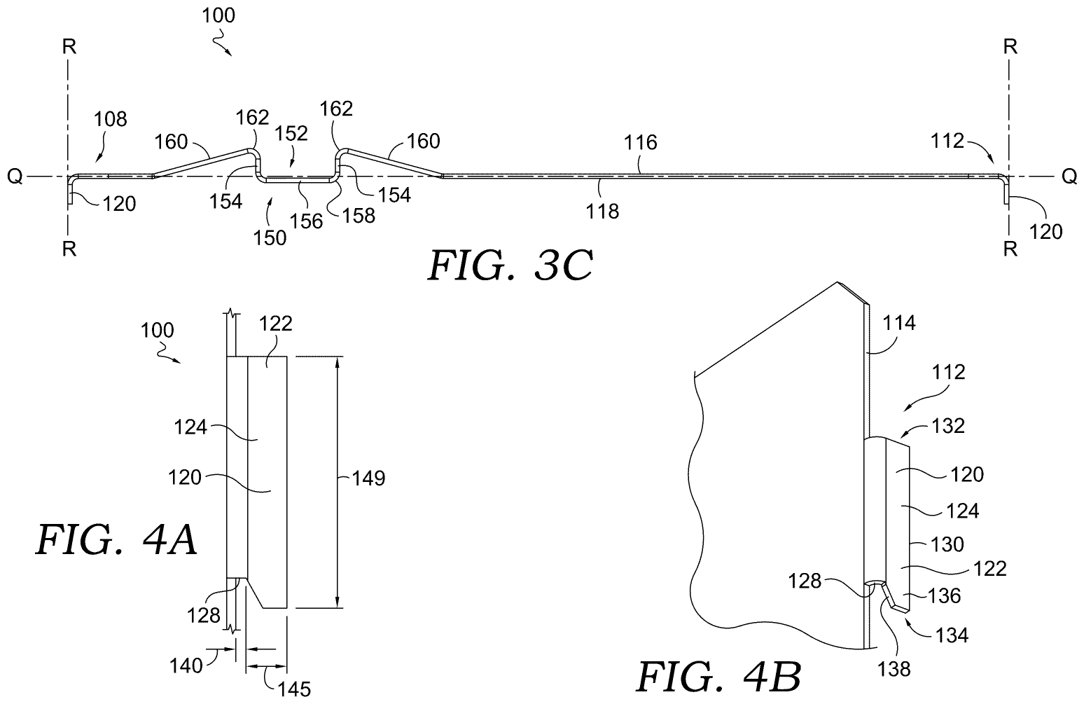

Turning to FIGS. 3A, 3B, and 3C, an example wall panel 100 in accordance with the present disclosure is illustrated. Wall panel 100 includes a body portion 102 having a top end 104, a bottom end 106, a first side 108 having a first side edge 110 and a second side 112 having a second side edge 114. When the wall panel 100 is in an installed orientation, the top end 104 is the end of the wall panel 100 closest to the ceiling 16 of the cargo compartment 24, and the bottom end 106 is the end of the wall panel 100 closest to the floor 18 of the cargo compartment 24. In the example of FIG. 3A, the body portion 102 comprises a first face 116 that, when the wall panel 100 is installed, faces towards the interior of the cargo compartment 24, and a second face 118 that faces towards a side wall of the cargo compartment 24. In an example, the corners 119 of the wall panel 100 may be chamfered (as shown in FIG. 3A) or rounded to eliminate sharp points for safety purposes.

Extending from the first side edge 110 and the second side edge 114 are a plurality of tabs 120. In the example of FIG. 3A, the tabs 120 are evenly spaced, with corresponding parts of adjacent tabs being a distance 146 (FIG. 3B) apart and sized to be insertable into the apertures 42 of the vertical logistics posts 30. In an example, the distance 146 is equal to the distance 46 between the top edges of adjacent apertures 42 in the vertical logistics post 30. In other examples, the distance 146 is a multiple of the distance 46 between adjacent apertures 42.

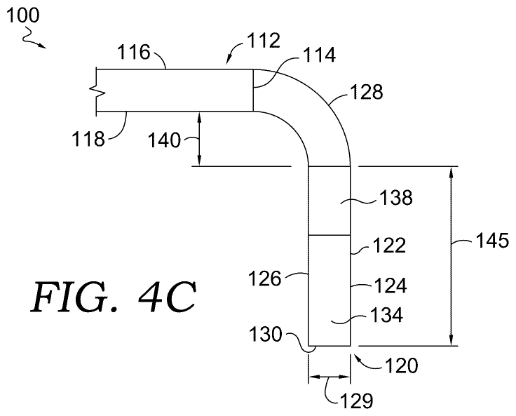

In an example, the tabs 120 initially extend away from their respective edges in the plane Q-Q (FIG. 3C) of the wall panel 100 before curving away from the first face 116 (i.e., towards the direction of the vertical logistics post 30 to which it will be attached), forming a connecting portion 128 that flows into tab body 122. In the example of FIG. 3C, the connecting portion 128 is curved, but it is to be appreciated that other configurations are within the scope of this disclosure. Each tab body 122 comprises an outer face 124 and an inner face 126, and a tab edge 130 opposite the connecting portion 128. The tab body 122 has a top end 132 and a bottom end 134, and a thickness. In examples, the outer face 124 and inner face 126 adjacent the tab edge 130 are flat and oriented vertically at a 90 degree angle to the plane Q-Q of the wall panel 100. The bottom end 134 comprises a protrusion 136 positioned adjacent the tab edge 130 that extends downwards towards the floor 18 (when the wall panel 100 is installed) and towards the bottom end 106. In an example, the inner edge 138 of the protrusion 136 closest to the second side edge 114 of the wall panel 100 is angled. When viewed from the bottom, as in FIG. 4C, it can be seen that a gap 140 is formed between the protrusion 136 and the second surface of the wall panel 100 adjacent the edge from which the tab 120 extends. In examples, the minimum width of this gap 140 is the wall thickness 37 of the central column 36.

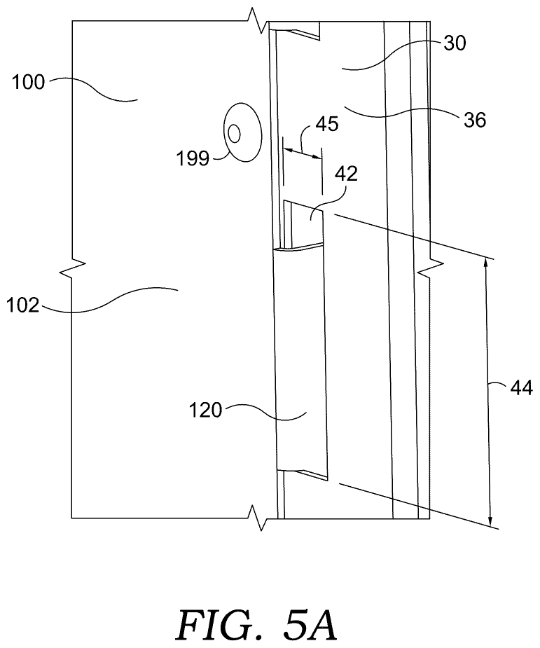

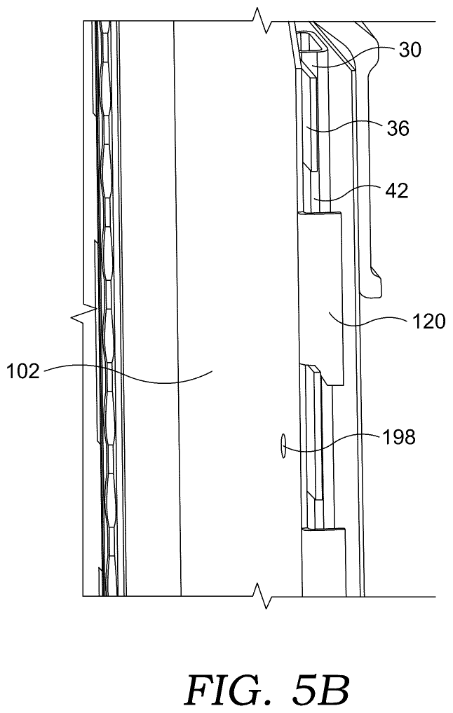

The tab body 122 (not including connecting portion 128) has a width 145 (e.g., FIG. 4A and 4C), which extends from the tab edge 130 to a transition from the angled inner edge 138 to the connecting portion 128. The width 145 is selected so that the tab can fit within the space within the vertical logistics post when the tab is fully inserted and engaged with the apertures 42 and the vertical logistics post is secured to the wall of the cargo compartment. Furthermore, in at least some examples, the length of the tab 149, from the top end 132 to the bottom end 134 (including the length of protrusion 136) is less than the longitudinal length 44 (e.g., FIG. 5A) of the apertures 42 in the vertical logistics post 30.

In examples, the tabs 120 are integrally formed with the body portion 102 of the wall panel 100 and are then bent into the proper orientation. In other examples, they can be separately formed and subsequently attached to the body portion 102, e.g., via adhesives, bonding, welding, and/or fasteners. Furthermore, while the example shown in FIG. 3A shows the tabs 120 attached to the edges of the body portion 102, one of skill in the art can readily understand that alternative positioning of the tabs 120 (e.g., on the backside of the panel) are also within the scope of the present disclosure.

As shown in FIGS. 5A and 5B, the tabs 120 of one side of the wall panel 100 can be inserted into aligned apertures 42 of one vertical logistics post. In addition, where an adjacent vertical logistics post 30 includes similarly arranged apertures 42, the tabs 120 on the other side of the wall panel 100 can simultaneously be inserted into the apertures of the adjacent vertical logistics post 30. The entire wall panel 100 can then be shifted downwards so that the protrusions 136 of the tabs 120 engage with the bottom edges of the apertures 42 into which they have been inserted. It can be seen that the angled inner edge 138 of each tab 120 may help guide the wall panel 100 as it is moved downwards so that the tabs 120, with the assistance of gravity, help to pull the wall panel 100 more closely against the vertical logistics post 30. Once the wall panel 100 is shifted downwards so that the bottom edges of the apertures 42 abut the connecting portions 128 of the tabs, a user can release the wall panel 100, with the protrusions 136 preventing the wall panel 100 from falling or rotating out of position.

In some examples, the wall panel 100 can subsequently be secured to the vertical logistics post 30 via one or more fasteners (e.g., fastener 199, in FIG. 5A). That is, in some instances, the wall panel 100 can include one or more through holes 198 in the body portion 102, and a fastener 199 can be inserted through the through hole 198 and into the vertical logistics posts 30 (or into some other structure behind the wall panel 100).

In at least some examples, the width 142 of the wall panel 100 from the outer faces of the tabs on the first side 108 to the outer faces of the tabs 120 on the second side 112 is equal to or slightly less than (e.g., to account for manufacturing tolerances and the contraction/expansion of materials) the distance between the centerlines 39 of the vertical logistics posts 30 to which the wall panel 100 is being attached. It can readily be appreciated that multiple wall panels 100 having the same width can therefore be attached to a corresponding array of vertical logistics posts 30 space evenly along the a wall of a cargo compartment 24. For example, the overall width of the wall panel 100 may be about 24 inches for examples where vertical logistics posts 30 are placed with their centerlines 39 spaced 24 inches apart. For examples where the vertical logistics posts 30 are at different spacing, the width (and number and spacing of the recesses) would similarly be modified consistent with this disclosure. Furthermore, in an example, the thickness 129 of each tab body 122 is equal to or less than half the width 45 of the apertures 42. Thus, tabs 120 from adjacent wall panels 100 can each be inserted to the same vertical logistics post 30. This arrangement allows for the multiples of the same wall panel 100 to be used to form an inner wall within the cargo compartment 24, as shown, e.g., in FIG. 1A.

In at least some examples, the body portion 102 of wall panel 100 may include a plurality of apertures 177 (such as those shown in the close-up of FIG. 3A) at various different positions, configured for the installation of different components and accessories, such as decking beams (such as conventional A or E decking beams) or logistics straps. The apertures 177 can be the same shape and size or of different sizes and shapes. In some examples, the apertures 177 may be disposed in a plurality of horizontal rows with consistent spacing between neighboring apertures 177 in each row. In other examples, vertically neighboring rows may be provided such that apertures 177 are aligned vertically along the same line, while in other examples the apertures 177 may be disposed in a staggered orientation. Other patterns of apertures 177 are also contemplated to be within the scope of the present disclosure.

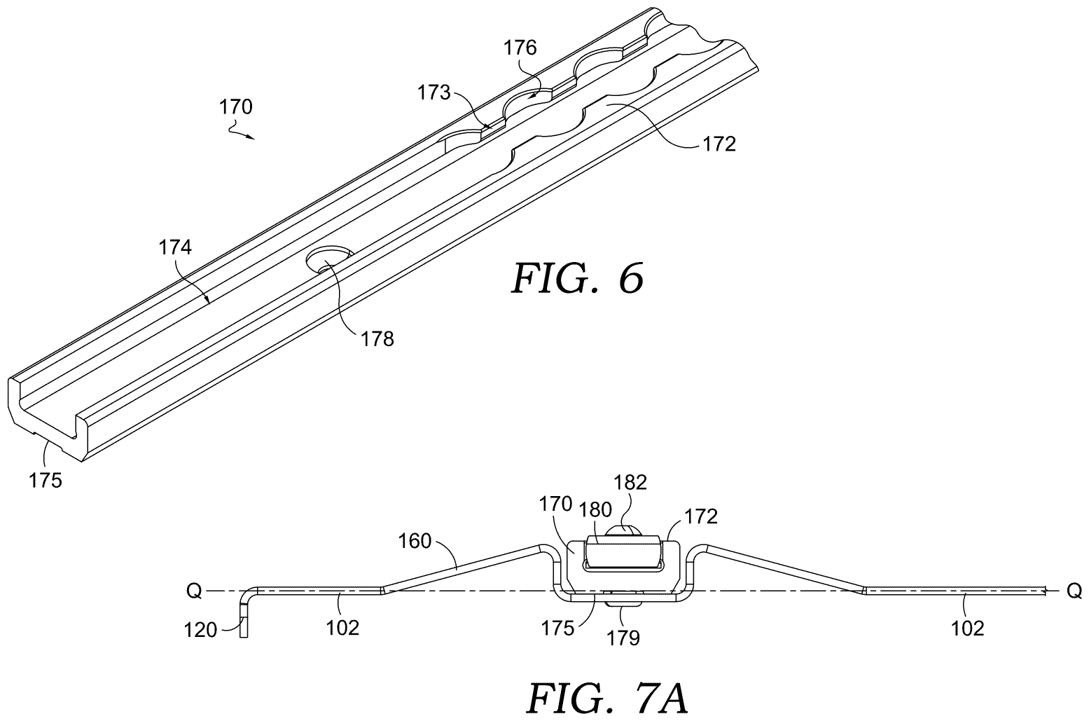

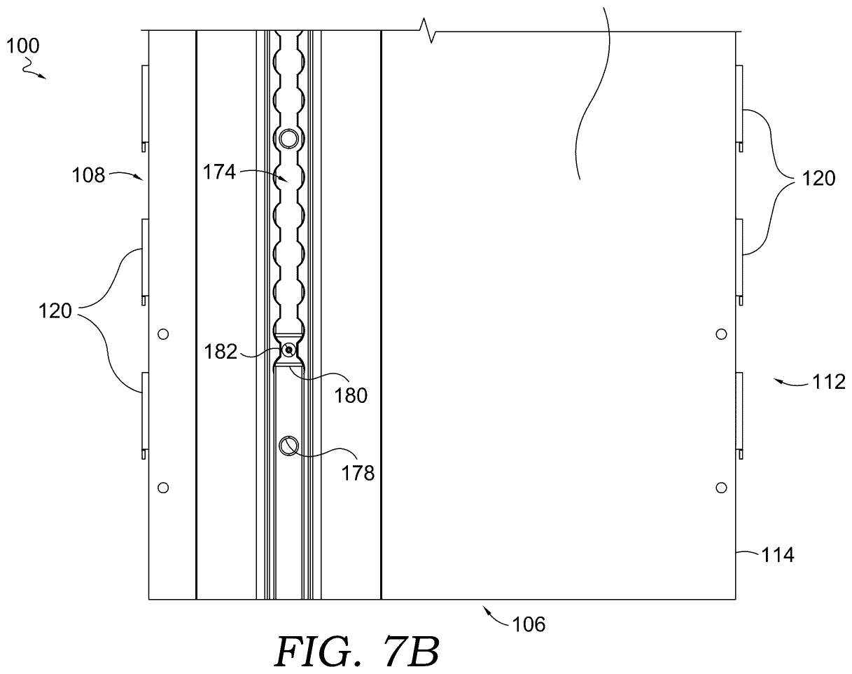

In at least some examples, referring back to FIG. 3C, the body portion 102 of the wall panel 100 may include one or more recessed portions 150. In the example of FIG. 3A (and as also shown in FIGS. 3B-C and FIGS. 7A-B), the recessed portion 150 extends vertically along the entire height 144 of the wall panel 100. In other examples, the recessed portion 150 may extend along only a portion of the wall panel 100 or may be omitted entirely. Examples where multiple recessed portions 150 are positioned across the width of the wall panel 100 (e.g., extending horizontally from side to side) are also contemplated to be within the scope of the present disclosure.

The recessed portion 150 defines an elongate void 152 that may provide room for a elongate track 170 or a similarly shaped component. The elongate track 170, such as the one shown in FIG. 6, may be of a pre-existing and standardized design configured to slidingly and lockably receive a slidable shoe, carriage, latch, etc. on an end of a captive beam to allow the captive beam to be retained at a desired position along the length of the elongate track 170. In examples, the elongate track 170 may comprise a channel 174 and a slot 173 in its interior-facing surface 172 with a plurality of circular cutouts 176 formed in the slot. The elongate track may also have a back 175 into which one or more apertures 178 are formed to allow fasteners to be used to attach the elongate track to another component or surface.

The recessed portion comprises side walls 154 and a back wall 156, with the back wall 156 being parallel to the plane Q-Q of wall panel 100. For example, the back wall 156 can be co-planar with the plane Q-Q or in a different plane that is parallel with the plane Q-Q. In the example shown in FIG. 3B, adjacent the recessed portion 150 on either side is an angled wall 160, which angles out of the plane Q-Q of the wall panel 100. The side walls 154 are connected to the back wall 156 by corners 158. In the example shown in FIG. 3B, the side walls 154 are connected to adjacent angled walls 160 via corners 162.

As seen in FIG. 3B, the back wall 156 of the recessed portion 150 can be closer to the wall of the cargo container (when the wall panel 100 is in an attached position) than the plane Q-Q of the body portion 102 of the wall panel 100. That is, the face of the back wall 156 facing towards the wall of the cargo container can be closer to the wall than the face of the other walls (e.g., 102) of the panel that are aligned in the plane Q-Q. However, it is to be readily appreciated that the positioning of the back wall 156, and thus the positioning of an elongate track 170 disposed within, can be adjusted.

For example, referring to FIG. 7A, if it is desired to have the interior-facing surface 172 of the elongate track 170 to be flush with the first face 116 of the wall panel 100, then the configuration of the recessed portion 150 and/or angled walls 160 can be modified, for example, by lengthening the side walls 154 and/or reducing/eliminating the angle of angled walls 160. One of skill in the art will readily understand that other components of the system, such as the length of the tabs 120 and or the dimensions of the vertical logistics post 30, may also need to be adjusted to provide additional space between the wall panel 100 and the wall of the cargo compartment 24. One of skill in the art may also readily appreciate that the dimensions of the recessed portion 150 can be modified to accommodate other types and sizes of tracks or other components.

As shown in FIGS. 7A and 7B, the elongate track 170 may be secured to the wall panel 100 by one or more fasteners 179. In some examples, a locking lug 180 can be inserted into one of the circular cutouts 176 of the elongate track 170, which prevents the shoe 50 of the beam 51 from sliding out further down the elongate track 170 than desired.

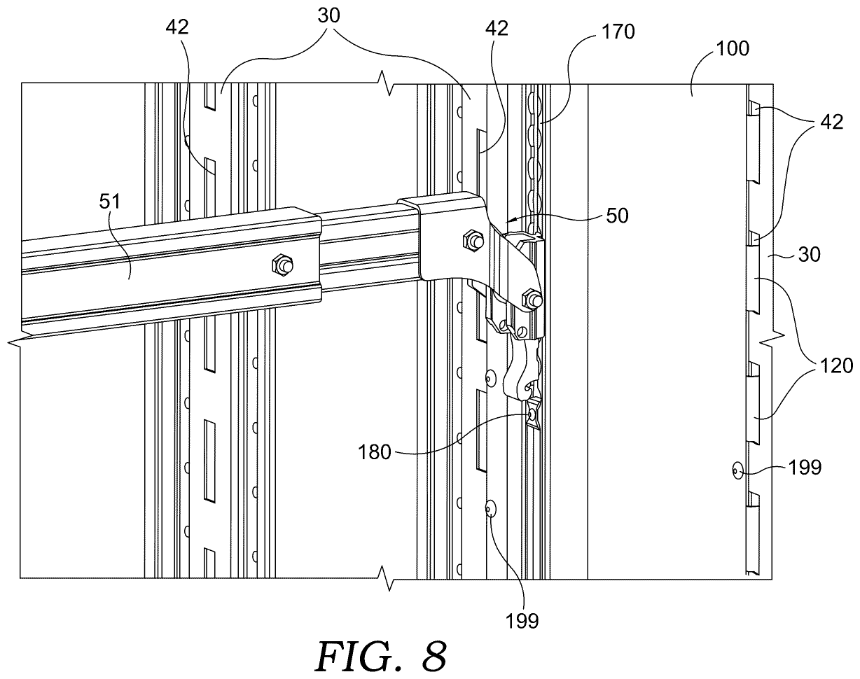

A plurality of walls panels 100 thus configured with elongate tracks 170 may be used to implement known captive beam systems within the cargo compartment 24. As shown in FIGS. 2 and 8, captive beam systems may include a shoe 50 that supports one end of a beam 51, which may be a decking beam, and is received and supported by an elongate track 170 attached to a wall panel 100 on one side of the cargo compartment 24, with the opposite end of the beam 51 being supported by a second shoe 50 that is received within a second elongate track 170 attached to a wall panel 100 positioned on the opposite side wall of the cargo compartment 24. The shoes 50 are configured to be slidable and releasably lockable within the elongate tracks 170, to allow the beam 51 to be positioned and re-positioned at desired heights within the cargo compartment 24. In examples, the shoe 50 includes a fitting that is selectively received within one of a plurality of corresponding circular cutouts 176 or lugs/nodes within the track to fix the shoe 50 (and therefore the beam 51) in the desired position. When the beams 51 are not desired (such as during loading and unloading), the beams 51 can be slid along both opposite elongate tracks 170 toward the ceiling 16.

The wall panels 100 may be sized to extend from the floor 19 of the cargo compartment to the ceiling 26 of the cargo compartment, or may be shorter than the height of the wall. The elongate tracks 170 may be the same length as the height of the wall panel 100, or may be longer or shorter than the wall panel, dependent upon the desired length of travel of the captive beam (discussed above) that slides within the elongate track 170 and the desired stowed height of the captive beam when not in use.

It is to be appreciated that wall panels 100 opposite each other on opposing side walls 12, 14, can have configurations that essentially “mirror each other” with respect to features that require a component to be attached to each. For example, a wall panel 100 such as the one shown in FIG. 3A that has a recessed portion 150 that that positioned is closer to one side (e.g., the first side 108) than the other (e.g., the second side 112), should be used opposite a wall panel where the recessed portion is closer to the other side of the wall panel, so that their respective recessed portions will be aligned when the wall panels are installed opposite each other. A wall panel with a mirrored configuration, such as wall panel 300 in FIG. 1, can also be used along the same wall as wall panel 100. It is to also be appreciated that using wall panels with differently positioned recesses along the same wall can allow a user to customize the spacing between respective captive beams. For example, an array of several different versions of the wall panel can be created, and a subset of the array selected to be installed on the wall to customize sizes. Wall panels 100 having recessed portions centered 6 inches, 12 inches, and 18 inches away from a first side edge 110 allows for a variety of different lengths between the elongate tracks 170 within the recessed portions 150. Furthermore, as shown in FIG. 1, wall panels 100, 300 do not have to be attached to the wall directly adjacent to each other.

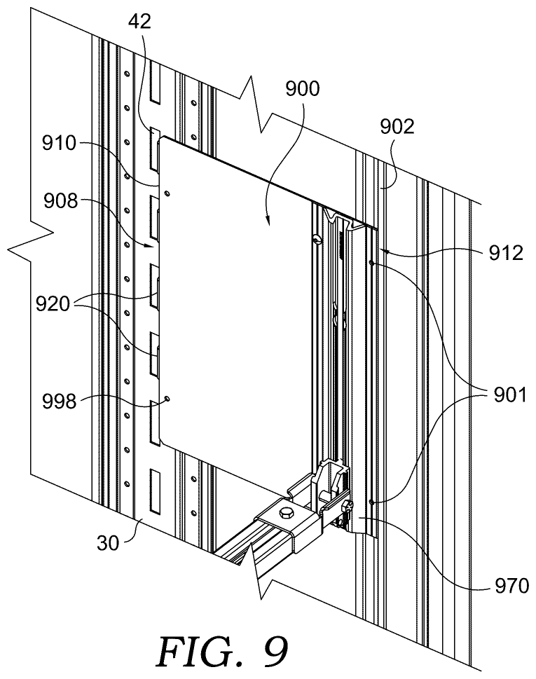

In some situations, e.g., near the end of a wall section, such as near the front or back end of a cargo compartment a variation of the wall panel describe above may be used. Referring to the example wall panel 900 shown in FIG. 9, tabs 920 may be positioned only along one edge, such as the first edge 910 of the first side 908 of the wall panel 900. The other side of the panel (e.g., second side 912), can be attached to the wall using conventional means such as by using fasteners through holes 901. In an example, the portion of the wall to which the second side 912 is fastened to may be reinforced (e.g., with reinforcing section 902) so that the wall panel 900 can be properly supported. While the tabs 920, after being inserted into apertures 42 of the vertical logistics post 30 may be insufficient by themselves to fully support the weight of the wall panel 900, sufficient weight can be supported so that a user can use a single hand to keep the wall panel 900 in place, allowing the other hand to be used to secure the second side 912 with fasteners through holes 901. The wall panel 900 can then be released by the user, and the first edge 910 can then further secured, e.g. with fasteners through holes 998. The example wall panel 900 of FIG. 9 also shows an alternative configuration of an elongate track 970, which may be secured to the surface of the wall panel 900 without it being housed in a recess.

In the examples shown herein, the wall panel 100 may be constructed from a single sheet of material that is formed into the desired orientation by bending, stamping, machining, or a combination thereof. In some examples, the wall panel 100 is formed by steel, while in other examples, the wall panel 100 may be formed by other metals, and in other examples, the wall panel 100 may be formed by a composite or plastic, or a combination of multiple materials. One of ordinary skill in the art with a thorough review and understanding of this disclosure, as well as an understanding of the loads to be supported by the wall panels 100 and overall wall system, will be able to determine the type of material that is best used for the wall panels 100 based upon cost, availability, and weight considerations.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof.

1. A wall system for a cargo compartment, the wall system comprising:
a wall panel comprising a body portion having a top end, a bottom end, a first side, a second side, a front face, and a back face;
the body portion comprising a planar wall extending from the top end to the bottom end and from the first side to the second side,
the first side comprising at least one tab, each tab comprising a face that is angled relative to a segment of the planar wall abutting the respective side;
wherein the first side is configured to be attached to a first vertical logistics post secured to or integrated into a side wall of the cargo compartment.

2. The wall system of claim 1, wherein:
the at least one tab is a first tab, and
the second side comprises at least a second tab configured to be attached to a second vertical logistics post secured to or integrated into a wall of the cargo compartment.

3. The wall system of claim 1, wherein the body portion the planar wall comprises a recessed portion that extends from the front face towards the back face and defines an elongate void in the front face.

4. The wall system of claim 3, further comprising an elongate track disposed within the elongate void of the recessed portion and in contact with one or more surfaces of the recessed portion, such that an outer surface of the elongate track, when disposed within the elongate void of the recessed portion, is parallel with the planar wall of the body portion.

5. The wall system of claim 4, wherein the second side comprises at least a second tab configured to be attached to a second vertical logistics post secured to or integrated into a wall of the cargo compartment, and first tab and the second tab are configured to be inserted into one of a plurality of apertures in the first vertical logistics post and the second vertical logistics post respectively.

6. The wall system of claim 5, wherein the plurality of apertures are vertical slots positioned along a first central column of the first vertical logistics post and a second central column of the second vertical logistics post respectively.

7. The wall system of claim 6, wherein the at least one tab further comprises a protrusion extending downward.

8. The wall system of claim 7, wherein the body portion further comprises a first angled portion and a second angled portion disposed on respective sides of the recessed portion, the first angled portion and the second angled portion each having a planar surface that is angled with respect to the planar wall of the body portion.

9. The wall system of claim 8, wherein the wall panel is a first wall panel, and the first tab configured so that a third tab on an second wall panel can concurrently be inserted into the same aperture of the plurality of apertures, the third tab being similarly configured to the first tab.

10. The wall system of claim 9, wherein the first tab and the third tab each have a tab width, the aperture has an aperture width, and the tab width is less than or equal to half of the aperture width.

11. A wall panel for use in a cargo compartment, comprising:
a body portion and first and second end portions that are disposed on respective outboard sides of the body portion and define respective first and second outer vertical edges of the wall panel,
the body portion comprising a planar wall surface, a recessed portion defining an elongate void configured to receive an elongate track configured to engage a captive beam, and at least one aperture configure to receive and support a decking beam; and
at least one of the first and second end portions each comprising at least one tab, each tab comprising a planar tab surface that is perpendicular to the planar wall surface of the body portion and configured to be received within an aperture in a central column of a vertical logistics post.

12. The wall panel of claim 11, wherein the recessed portion is disposed between a first angled portion and a second angled portion, each having a planar surface that is angled in relation to the planar wall surface.

13. The wall panel of claim 12, further comprising a second recessed portion defining a second elongate void configured to receive a second elongate track configured to engage an end of a second captive beam.

14. The wall panel of claim 13, wherein the recessed portion is disposed between a third angled portion and a fourth angled portion, each having a planar surface that is angled in relation to the planar wall surface.

15. A method of installing a wall system for a cargo compartment comprising a side wall including a first vertical logistics post along or adjacent to the side wall, the first vertical logistics post comprising a first central column having a first plurality of apertures, and a second vertical logistics post along or adjacent to the side wall and spaced a first length away from the first vertical logistics post, the second vertical logistics post comprising a second central column having a second plurality of apertures, the method comprising:
attaching a wall panel to the first vertical logistics post and the second vertical logistics post, the wall panel comprising a body portion and first and second end portions that are disposed on respective outboard sides of the body portion:
the body portion comprising a planar wall surface, a recessed portion defining an elongate void configured to receive an elongate track configured to engage an end of a captive beam; and
the first and second end portions each comprising at least one tab, each tab comprising a planar surface that is perpendicular to the planar wall surface of the body portion and configured to be received within one of the first plurality of apertures and the second plurality of apertures;
wherein the attaching a wall panel comprises inserting each tab of the first and second end portions of the wall panel into corresponding apertures of the first plurality of apertures and the second plurality of apertures.

16. The method of claim 15, wherein each tab further comprises a protrusion, and the attaching a wall panel further comprises shifting the panel downwards after each tab is inserted into the corresponding apertures so that each protrusion engages with a bottom edge of each of the corresponding apertures in which each tab has been inserted.

17. The method of claim 16, wherein the attaching a wall panel further comprises securing the wall panel to the first vertical logistics post and the second vertical logistics post with one or more fasteners.

18. The method of claim 15, wherein the cargo compartment comprises an opposite side wall comprising a third vertical logistics post along or adjacent to the opposite side wall of the cargo compartment, and a fourth vertical logistics post along or adjacent to the opposite side wall of the cargo compartment spaced a second length away from the third vertical logistics post, the method further comprising:
attaching a second wall panel having a mirrored configuration of the wall panel to the third vertical logistics post and the fourth vertical logistics post.

19. The method of claim 18, wherein the wall panel comprises a first plurality of wall apertures and the second wall panel comprises a second plurality of wall apertures, and at least one of the first plurality of apertures is opposite at least one of the second plurality of wall apertures.

20. The method of claim 19, further comprising of attaching a securement component to the at least one of the first plurality of wall apertures and the opposite at least one of the second plurality of wall apertures respectively.

21. The method of claim 20, wherein the second wall panel comprises a second elongate track and the end of the captive beam comprises a first end, the method further comprising:
attaching the first end and a second end of the captive beam to the elongate track and the second elongate track respectively.

22. The method of claim 18, wherein the side wall of the cargo compartment comprises a fifth vertical logistics post along or adjacent to the side wall of the cargo compartment spaced a third length away from the second vertical logistics post;
the method further comprising:
attaching a third wall panel to the second vertical logistics post and the fifth vertical logistics post.

23. The method of claim 22, wherein the third wall panel comprises a third panel tab that is configured similarly to the at least one tab of the wall panel.
